(19) United States
(12) Patent Application Publication
(10) Pub. No.: US 2006/0073796 A1
(43) Pub. Date: Apr. 6, 2006

(54) Apparatus for receiving and issuing data through a display on an interior of a passenger compartment of a motor vehicle

(75) Inventors: Andrea Collavo, Lentiai - Belluno (IT); Bettino Perissinotto, San Dona di Piave - Venezia (IT)

Correspondence Address: John S. Egbert;Harrison & Egbert, 7th Floor, 412 Main Street, Houston, TX, 77002, US

(73) Assignee: PLASTAL SPA, Pordenone (IT)

(21) Appl. No.: 10/956,533

(22) Filed: Oct. 1, 2004

(51) Int. Cl. H04B 1/04

(52) U.S. Cl. 455/116

(57) ABSTRACT

This invention has as an object a complex multifunctional apparatus for receiving and issuing data through of the visualization of the latter by means of a display or a monitor on the interior of the passenger compartment of a motor vehicle, with a control device and mobile telephone remote control of the type with bluetooth technology.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention finds particular if not exclusive application in the field of motor vehicles in order to allow wireless communications to and from the passenger compartment.

### BACKGROUND OF THE INVENTION

In the field of mobile telephony, notable progress has been made in the sector, mainly with respect to the apparatus itself and the functions that it can carry out. Sales of mobile telephones have brought about the undoubtedly imprudent widespread use of mobile telephones in the car since the fact that the telephone is always at the user's disposal induces the driver to enjoy the use of its services. Moreover, that is to say that the use of the mobile telephone is not linked only to the will of the owner of the apparatus because the fact that the user can receive calls, messages and the like, serves to distract the driver as it attracts his attention in potentially dangerous moments. Certain General Governments, in order to clamp down on the phenomenon of the use of the conventional mobile telephones inside the vehicle, have agreed to significantly sanction the use of mobile telephones while driving if not used with homologated devices (such as ear pieces or hands-free devices). However, if on one hand, initiatives of this type appear valuable in their objective, on the other hand they do not seem to provide a decisive solution to the problem because the connection of the personal telephone to these devices is not automatic. In this way, said devices are only used occasionally even if available in the car.

After the initial development of vehicular telephones, alternative solutions were developed that consist in providing integrated systems, which in addition to the car phone with its GSM module and SIM card, include:
CD/DVD reader
car radio
navigator
voice calling

They are first generation systems that are usually integrated into the dashboard of the motor vehicle, in a more or less high central position and that coincide with the middle axis of the passenger compartment above the central tunnel. These systems provide an on-board monitor by means of which all the functions selected are shown using an alphanumeric keyboard.

In any case, these solutions also provide the use of an on-board integrated telephone, requiring the manual insertion of the SIM, or its duplicate, into the vehicular telephone.

More developed systems can also provide a remote control that can be integrated into the steering wheel. These systems fall into the apparatus typology that faces the problem of reducing as far as possible the distraction of the driver, even if only momentary, due to the search for function keys present on the telephone apparatus, by the possibility of using a remote control with base functions.

Prior Art

In the study for the safest positions for control devices of mobile functions, some have perceived that the fundamental requisite could be that of not lowering the eyes but only rotating them laterally, or if necessary raising them a little, whilst always remaining oriented in the direction of the road. Consequently, the conclusion has been drawn, that in any case, the lateral movement, for example towards the rear-view mirror, is generally faster and always allows the perception of that which occurs beyond the windscreen.

Therefore, U.S. 2002/0004416 (Baratono) has produced a so-called hands-free system that combines a mobile phone or a telephonic unit with a car rear-view mirror. In particular, a housing is provided that incorporates a rear-view mirror on the part directed towards the windscreen, on the inside of which a removable cellular phone can be introduced to receive and make telephone calls. Said housing is provided with an electronic circuit to which the mobile phone must be physically connected by means of manual operation. Furthermore, the mirror includes: loudspeaker, microphone and keyboard to render the telephonic functions accessible to the driver.

GB2356312 (Abbas), describes a somewhat similar solution to the previous one. In more detail, it can be affirmed that the latter differs from the first due to the fact that it provides the different positioning of the keyboard that in this case is obtained linearly and in sequence along the lower side of the mirror. A longitudinal display is positioned adjacently, to show the data always in linearly.

Prior Art most Similar to the Invention

ITTV2002A000072 (Collavo et al) describes a control device with remote control of the cellular phone that automatically connects to the latter (within the range of approx. 10 m). In this way the driver is not required to manipulate the telephone that can remain in its existing location (pocket, bag, etc.). Said control device consists of a container that preferably also includes the rear-view mirror. In said container, in correspondence to one side, the side facing the passengers in the passenger compartment, are provided:
a microphone
at least one ON/OFF/Vocal Activator switch
a display (optional) for viewing the telephone No (incoming or outgoing)
a base keypad
a loudspeaker (optional)
a comprehensive electronic circuit of a wireless bluetooth receiver/transmission system able to communicate with a cellular phone equipped with the same wireless technology.

Unlike the previous solution, U.S. Pat. No. 6,356,376 (Tonar et al.) suggests a rear-view mirror that is provided with a display to visualize data, such as for example the temperature or the compass points, in such a way that the image passes the rear-view mirror to appear in correspondence to the front of the latter.

U.S. Pat. No. 6,412,959 (Tseng) proposes a rear-view mirror device having a monitor or a display screen, this mirror being placed frontally with respect to the housing that is secured on a vehicle. A display screen is placed in the housing and placed behind the mirror element, and can be seen by means of the mirror element when the display screen is activated. A border circuit is joined to the display screen and is joined to an antenna to receive signals from other facilities. The housing can have one or more extensions.

U.S. 2002/0141086 (Lang et al.) describes a wing-mirror that provides an apparatus for reproducing images, such as a monitor. The Monitor is connected to a camera, which captures an area of vision on the side or behind the vehicle. U.S. 2002/0011927 (Lang et al.) also proposes a monitor associated to a wing-mirror, but unlike the previous example, at least one monitor contained in the housing of the rear-view mirror is visible by means of the reflective surface of the mirror. U.S. Pat. No. 5,689,241 (Clarke et al.) describes an apparatus to reveal the degree of attentiveness of the driver. Said device could be placed around the rear-view mirror or in correspondence to the dashboard.

Drawbacks

The proposals for a complex rear-view mirror, described earlier, if on one hand represent significant progress, on the other hand present limitations.

For example U.S. Pat. No. 6,356,376 (Tonar et al.) is provided with a display that only allows the visualization of data in alphanumeric form. In other words, the apparatus in question cannot show images. Furthermore, it does not provide for interaction with telephone systems and therefore does not provide for bluetooth wireless connectivity.

Unlike U.S. Pat. No. 6,412,959 (Tseng), U.S. 2002/0141086 (Lang et al.) and U.S. 2002/0011927 (Lang et al.) propose a monitor also of the type integrated onto the reflective surface of the mirror. However, said solutions do not provide the integration of the telephone remote control and above all the use of the display is limited to only a few functions (rear view camera, TV), sometimes purely for entertainment and therefore substantially dangerous.

However, each apparatus is not provided with other functions and moreover does not provide any system for mounting the command and control of the telephone and therefore not even with bluetooth wireless connectivity.

Also U.S. Pat. No. 5,689,241 (Clarke et al.) is not provided with a monitor and does not allow the use of a telephone remote system.

Finally, ITTV2002A000072 (Collavo et al) disposes of the sole function of mounting the main controls and functions of the cellular telephone in correspondence with the rear-view mirror. In this sense it appears as a limited apparatus, as it fails to provide interaction with other functions that are already known and usable individually by the user by means of the use of apparatuses separated from the body of the rear-view mirror. In addition, the presence of a display to visualize the data is exploited in a limitative way and closely linked to the visualization of the incoming telephone number.

The aim of this invention is to avoid certain aforementioned drawbacks by developing the idea provided in the invention ITTV2002A000072 (Collavo et al), by means of a system that completely satisfies the requisites of an automatic hands-free wireless device that is integrated with other functions (navigation, SOS alarms, aid to driving in reverse . . . ), that today are already significantly present on-board, and that can find in said physical housing the best ergonomic positioning to ensure optimum safety levels while driving.

### BRIEF SUMMARY OF THE INVENTION

This and other aims are achieved with this invention according to the characteristics as in the included claims, resolving the disclosed problems by means of a complex multifunctional apparatus for receiving and issuing data by means of visualizing the latter through a display or a monitor on the interior of the passenger compartment of a motor vehicle, with a control device and remote control of the cellular phone of the type with wireless technology, consisting of a container that incorporates at least:
a) a comprehensive electronic unit of a transmission/receiver system capable of communicating with a cellular phone provided with a wireless communication system;
b) its own power-supply circuit obtained by battery voltage;
c) a microphone;
d) at least one base keyboard: ON, OFF, Voice Activator, etc.;
e) at least one loudspeaker or the piloting of external loudspeakers (car radio);
f) rear-view mirror; and optionally at least one entrance for video signals;
g) a logic control unit of the optional functions;
h) a monitor and/or a display also of the type separated from the reflective front of the mirror;
i) a GPS unit and related antenna, possibly interfaced with a cartographic navigation system (optional) and/or a remote alarm management system;
j) Camera with video calling system;
k) sleep detection unit (optional).
   Advantages

In this way, certain advantages are achieved by means of the considerable creative contribution, the effect of which constitutes immediate technical progress.

A first aim is to produce a compact device, which in addition to the rear-view mirror function and to that which is provided in the patent ITTV2002A000072 (Collavo) (automatic hands-free), includes as many functions as possible positioned on the interior of the passenger compartment in an optimal position, that is to say as close as possible to the horizon and capable of interfering to a lesser extent with the usual vision of the driver with respect to previous solutions.

A second aim is the possibility of assembling the device in such a way as to offer the user an acquired interface, with simple reading and interpreting since it is able to reproduce the graphic representation most similar to that already known for cellular telephones.

A third aim is to develop a device that includes a camera, for the video broadcast of the user for the prospect of possible developments of the same product towards videotelephony systems (UMTS).

J A fourth aim, is to produce a device which provides a—sleep detection—device to discreetly reveal the degree of attentiveness of the driver, these detection means being placed in a position as close as possible and involved with greater frequency in the driver's line of vision.

A fifth aim, is also to provide a monitor or display, for example high-resolution, that can perform more functions by the visualization of the surrounding area by means of the cooperation with external cameras placed at the back or to the sides of the vehicle, by functioning as navigation systems with geographic maps obtained in real time from a connection towards suitable Internet sites or from the issue of video data in general, said monitor or display also being considered as an orientable element and separated from the reflective front of the mirror.

An additional aim is provide an apparatus to which can be added functions such as: GPS, SOS/Alarms via radio or GSM, telepass, rain/demisting sensors, radio remote control, courtesy lights-spotlights, radio, automatic alarms and others.

These and other advantages and aims will appear from the following detailed description of certain preferred embodiments with the aid of enclosed schematic drawings, the details of which are not to be considered limitative but only illustrative.

### BRIEF DESCRIPTION OF THE SEVERAL VIEWS OF THE DRAWINGS

FIG. 1 is an axonometric view of a component for a vehicle, represented in the form of a rear-view mirror, which incorporates the complex multifunctional apparatus.

FIG. 2, is a perspective view of one variant of the multifunctional complex apparatus in FIG. 1, with a monitor represented at the side of the rear-view mirror;

FIG. 3, represents a block scheme of a first possible design of the multifunctional complex apparatus in FIG. 1;

FIG. 4 represents a block scheme of a second possible design of the multifunctional complex apparatus in FIG. 1;

FIG. 5 is a block scheme of a third possible design of the multifunctional complex apparatus in FIG. 2;

FIG. 6 is one variant of the rear-view mirror joined with a monitor separated from the reflective surface;

FIG. 7, is a second variant of the rear-view mirror joined with a monitor separated from the reflective surface;

Finally, FIG. 8 is another variant of the rear-view mirror joined with a monitor of the orientable type, separated from the reflective surface.

### DETAILED DESCRIPTION OF THE INVENTION

With reference to the Figures, it is observed in the first place that a component for the passenger compartment of a vehicle, which includes the multifunctional complex apparatus, consists of a rear-view mirror 1 and 2.

Each rear-view mirror 1 and 2 uses a support element 100, which supports, in a cantilevered way, a shell 101 having the function of a housing or container. The rear portion of the shell 101, thus, facing the windscreen is substantially shaped in a harmonious way, while the anterior part corresponding to the side directed towards the interior of the passenger cabin provides an essentially flat facade. The latter was previously characterized by the association of an antiglare mirror 102. In this case, the area of the rear-view mirror 102, of the convertible type, antiglare, and possibly motorized, substantially consists of a longitudinal strip, restricted along the perimeter by a frame 103.

On the interior of the container 101 of each rear-view mirror 1, 2, the complex apparatus is received in an integrated way, essentially divided into two sections, a first section for wireless communication A, a second section for the management of the display B and possibly a third section C for the management of certain video functions, respectively

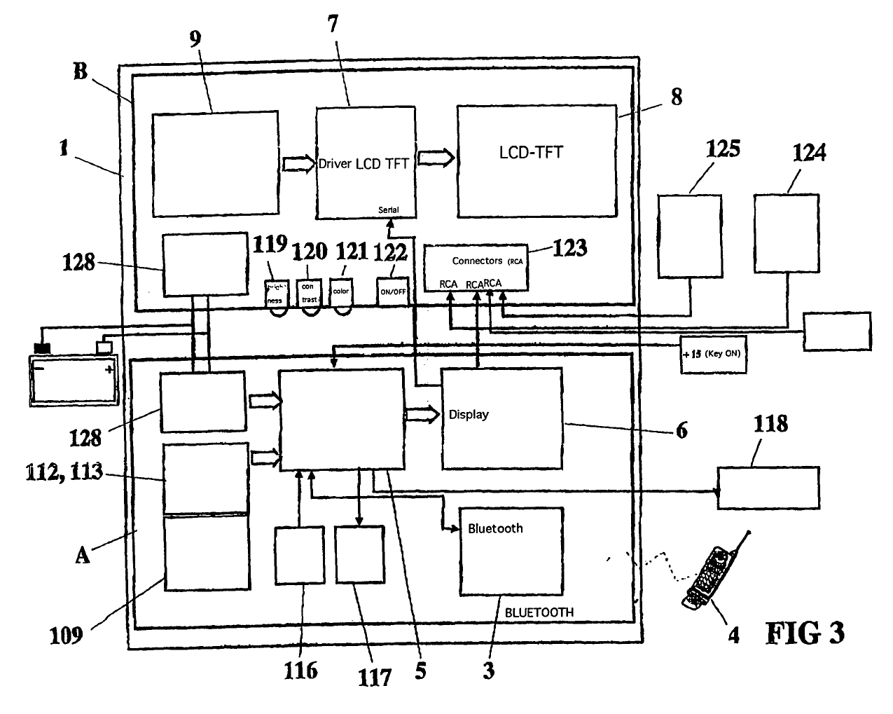

A first possible hypothesis of the multifunctional complex apparatus, (see block scheme in FIG. 3), includes a first section A of which at least one module of transmission/receiver 3 forms a part, which communicates in a remote way with the cellular telephone of the type predisposed to wireless communication, such as for example, a cellular telephone 4, reciprocally equipped with bluetooth technology.

A logic control and management device of the audio system 5 forms part of the complex apparatus integrated into the rear-view mirror 1, 2 and interacts with the transmission/receiver module 3 with related antenna, the ‘hands-free’” interface and the synchronized address list. The logic control and management device of the audio system 5 is accessed by means of a series of external function keys, placed for example along the base 104 of the frame 103. In more detail, said keys are placed in an aligned way, respectively from left to right, and can include partly or in all:
an index function key 105
a scroll-up function key 106
a scroll-down function key 107
a messages function key 108
a sequence of alphanumeric keys with double function 109.

Part of the keys mentioned, and in particular the alphanumeric keys (for use when stationary), could be produced by means of Touch Screen technology.

The frame 103 in correspondence to the sides, respectively left 110 and right 111, provides further keys that have the following functions:
an ON key 112 and an OFF key 113 placed astride the frame, preferably with a roughened surface in order to allow easy identification even in the case of a poor visibility;
a rounded key in relief 114 for the activation of the “hands-free” function under the ON key 112, and a second rounded relief key 115 placed below the OFF key 113 with “private” functions.

Furthermore, they are provided to communicate with the logic control and management device of the audio system 5, a microphone 116 and a possible loudspeaker 117. An additional function, considers the connection to the logic control and management device of the audio system 5 also of the car radio 118. In this case the logic control and management device of the audio system 5, can provide the management with more GSM cellular telephones and is capable of operating for the recognition and automatic deletion of the address book.

The logic control and management device of the audio system 5 is predisposed to communicate with a manager of the display 6 which allows the visualization of the incoming and outgoing number, as well as allowing the visualization of the message service SMS and the address book. The manager of the display 6 interacts with the second section B of the multifunctional complex apparatus, being connected to a driver of the display, which in turn, by means of a monitor 8 for example of the type LCD-TFT in color, shows the video data. The second section B of the multifunctional complex apparatus includes contrast, brightness and color regulating devices, respectively 119, 120 and 121, if such management is not automatic, as well as a relative conventional ON/OFF switch 122 to deactivate the function. In a possible variant, rather than being integrated in such a way as to show the image in correspondence to the reflective facade 102 the monitor/display 8 appears substantially separated. In one case provision is made for said monitor/display 8 to be integrated into a container, connected with the main container 101 of the rear-view mirror 1, 2 by means of an articulation in order to allow orientability.

Connectors 123, involve the section B display to which a camera for at least the rear and/or side vision of the vehicle 124 and a switch 125 to control the reverse function are to be connected respectively. In this way, the logic control device 9 controls the manager of the display 6, the rear camera 124, the bluetooth system 3 and the external video signals, interacting with the driver LCD-TFT 7.

Both sections A and B are supplied 128 by the existing line voltage on the interior of the compartment and can, if necessary be, supported by an auxiliary group.

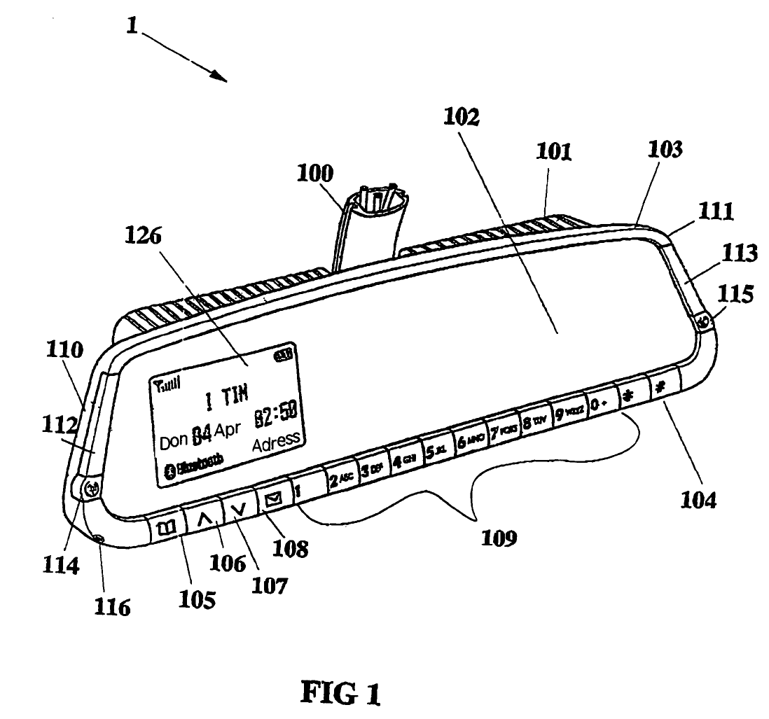

In the solution in FIG. 1 and with the block scheme in FIG. 3, the represented rear-view mirror 1 disposes of an image 126 mounted by means of the display/monitor 8 on the reflective front itself 102. Said image 126 appears integrated onto the front itself in such a way as to be visible to the user in a position close to one of the two lateral ends of the rear-view mirror 1. In this case, the image 126 that appears, reproduces where possible, the exact graphic that appears on the display of the user's cellular phone 4.

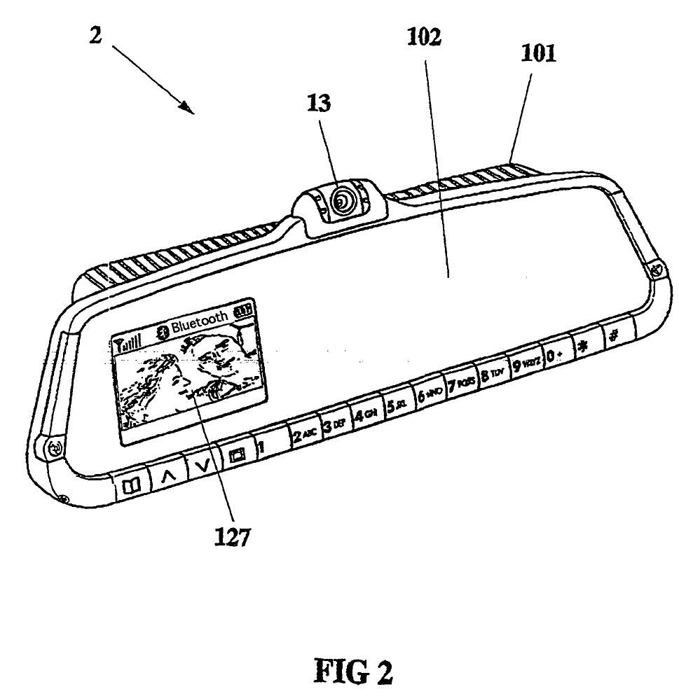

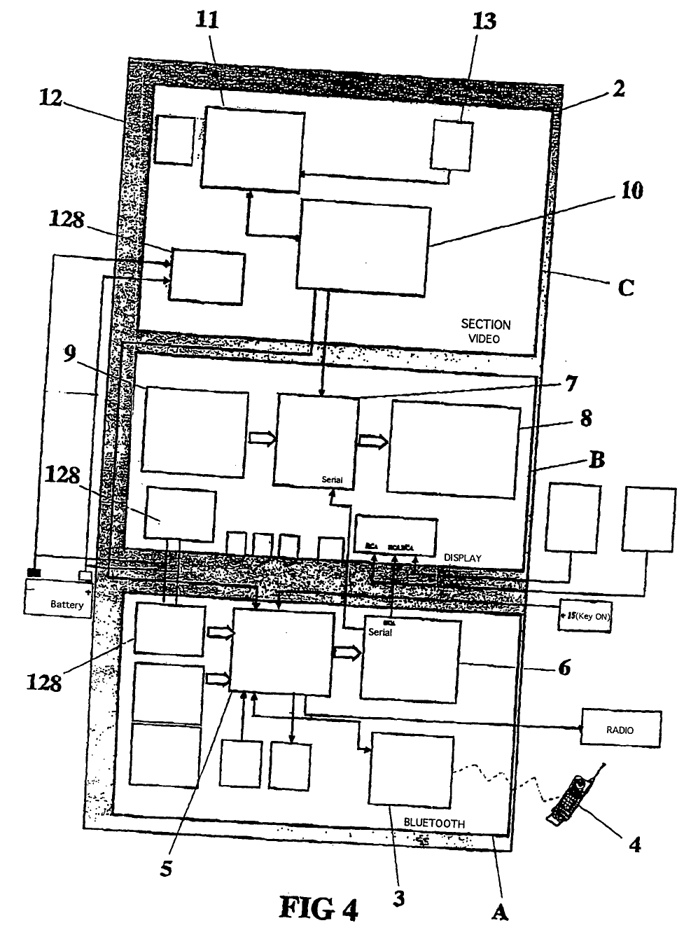

In the solution in FIG. 2, the represented rear-view mirror 2 disposes of an image 127 mounted by means of the display/monitor 8 placed on the interior of the container 101 or in the satellite container 101/2. In this case, the rear-view mirror 2 is of the type provided in correspondence to the frame 103, or in an intermediate position with respect to the upper edge, of a camera also of the orientable type 13. The block scheme represented in FIG. 4 is explicative of one possible solution that uses the camera 13. In this case, the multifunctional complex apparatus includes, in addition to the previous two sections, respectively A and B, the third section C that disposes of a logic control device 10 which manages a video-conference system.

Said logic control device 10 is connected to the driver LCD-TFT 7 of the second section display B and is connected to the logic control and management device of the audio system 5 of the first section A.

Conventionally supplied on a network, the video section communicates by means of the logic control device 10 with the bluetooth system 3/11 which is interfaced with the user's cellular phone 4. The logic control 10, by means of the block 11, can moreover integrate the UMTS function with the related antenna 12 or new wireless technologies such as WiFi.

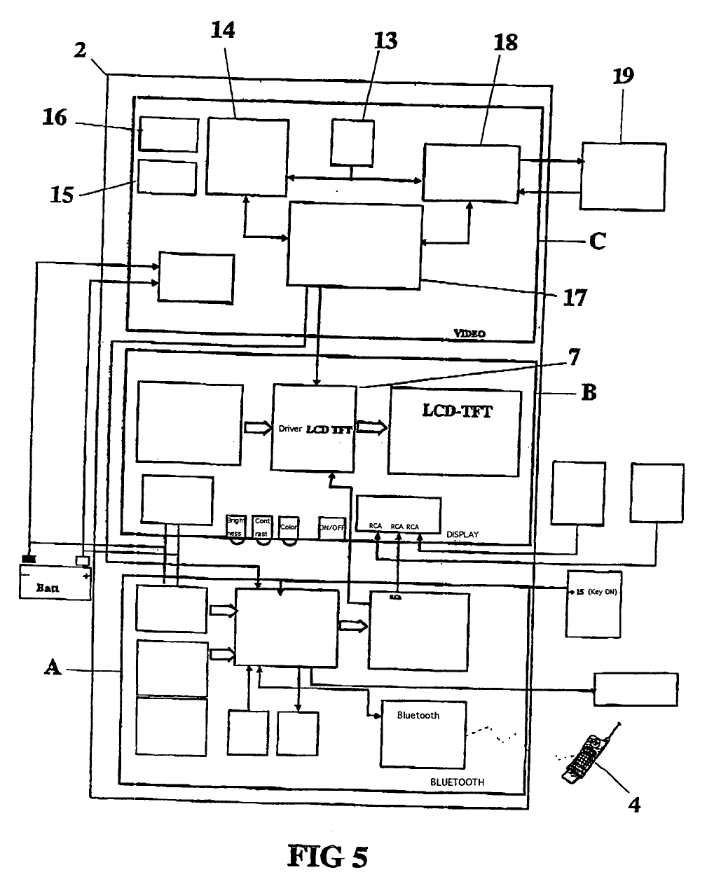

FIG. 5 is one possible variant, represented according to a block scheme, of the multifunctional complex apparatus integrated into the type 2 rear-view mirror. By implementing the previous solution, the video section 3 can also include a GPS/GSM system 14 with the optional possibility of having the UMTS system, with related antennae 15 and 16 and/or wireless technologies (WiFi, others). The GPS/GSM system 14 with the optional possibility of having the UMTS system is controlled by the logic control device 17 that communicates with the driver LCD-TFT 7. In this case, a device to establish the degree of attentiveness of the driver 18 can be added to the aforementioned functions that by means of a module that processes the image 19, has the aim of establishing the different degree of attentiveness of the driver. The camera 13 provided in the video section C is interfaced both with the GPS/GSM system 14, with the optional possibility of having the UMTS system as well as with the device to establish the degree of attentiveness of the driver 18. Both functions are controlled by the logic control device 17 which in this case, is equipped with an audible warning device to signal to the driver, with at least one possible alarm device (SOS by GSM with positioning of the vehicle (GPS) to a Call Center and video conference system.

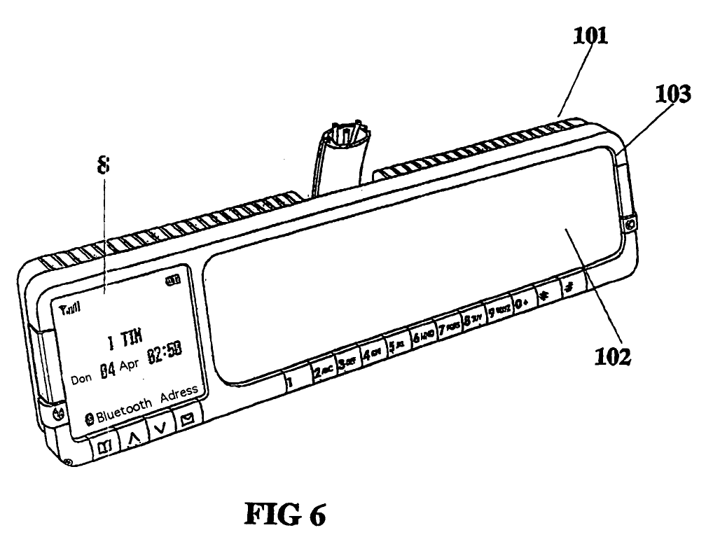

FIGS. 6, 7 and 8 are variations that concern structures of rear-view mirrors, which always provide the monitor/display, but are obtained in such a way as to be separated from the reflective surface.

As in FIG. 6, the rear-view mirror consists of a container 101 subdivided frontally into two areas, in this case the passenger side having the reflective surface 102, of the conventional antiglare type, while the driver side has the monitor 8. More particularly, the area intended to house the monitor 8 is divided from the reflective surface 102 by a vertical separating partition that is connected to the frame 103 that frontally defines the container 101.

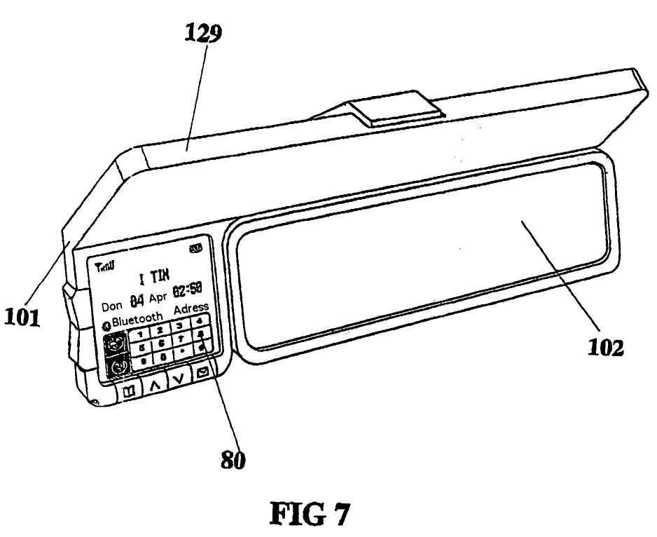

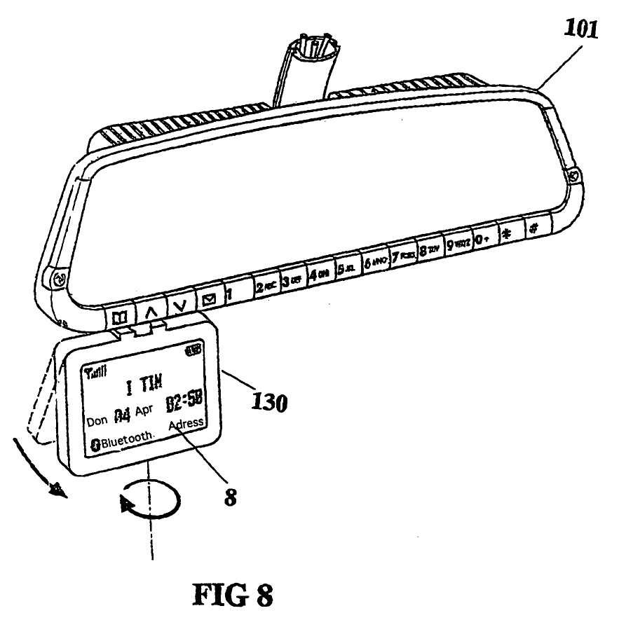

FIG. 7, represents a similar solution to the previous one. In this case the container 101 is configured as a structure that provides a cover 129 on the upper part, directed frontally and inclined slightly upwards. The lower part of the container supports, in an aligned way, the reflective surface 102 separated from the monitor 8 the latter being placed on the driver's side. In this solution the monitor 8 is represented with a lower portion provided with a keyboard of the touch screen type 80.

Finally, FIG. 8 represents the monitor 8 housed in an appendix 130 pivoted in an orientable way, along the lower edge of the container 101, at the side of the user driver. The appendix 130 is hinged to the container 101 in such a way as to allow not only the adjustment of the inclination of the visual surface, but also rotation in both directions of the latter, in such a way as to favour visibility.

1. Complex multifunctional apparatus for receiving and issuing data by visualization thereof through a display or a monitor on an interior of a passenger compartment of a motor vehicle, with a control device and remote control of a cellular phone of a type with wireless technology within a container, said apparatus comprising:
a comprehensive electronic unit of a transmission/receiver system in communication with a cellular phone provided with a wireless communication system;
a microphone;
at least one ON/OFF/Vocal Activator switch;
a base keyboard with a touch screen;
at least one loudspeaker or the piloting of external loudspeakers;
a monitor and/or a display;
at least one entry for video signals;
a GPS unit and related antenna, interfaced with a real time cartographic navigation system with maps obtained from Internet sites;
camera with video-calling capability; and
a sleep detection unit.

2. The complex multifunctional apparatus according to claim 1, wherein the container is joined to a rear-view mirror for an interior of a passenger compartment of a vehicle, an interior of the container being divided into at least two sections, a first section housing wireless communication and at least a second section for housing management of the display,
wherein said first section further comprises:
a transmission/receiver module in communication, in a remote way, with the cellular telephone of the type predisposed to wireless communicate, such as for example, a cellular telephone reciprocally equipped with bluetooth technology;
a logic control and management device of the audio system interactive with the transmission/receiver module with related antenna, the “hands-free” interface and the synchronized mailing list;
a keyboard that incorporates functions and ON/OFF switches;
a microphone and a possible loudspeaker connected to the logic control and management device of the audio system that also controls the car radio;
a manager of the data towards the module that manages the display; and
a second display section connected to the first by means of the display manager, being connected to a TFT LCD driver, which in turn shows the video data by means of a monitor.

3. The complex multifunctional apparatus, according to claim claim 1, further comprising a rear-view mirror and a TFT type monitor display or similar.

4. The complex multifunctional apparatus, according to claim 2, wherein said second section comprises contrast, brightness and color adjustment devices or automatic adjustment devices, a relative conventional ON/OFF switch and connectors to a camera for at least a rear and/or side view of the vehicle and a switch to control a reverse function, a logic control device controlling a display manager, the rear camera, the bluetooth system and the external video signals, interacting with the driver.

5. The complex multifunctional apparatus according to claim 2, wherein the first and second section are supplied by an existing line voltage on an interior of the passenger compartment and possibly supported by an auxiliary group.

6. The complex multifunctional apparatus according to claim 1, wherein the monitor/display is of the color LCD-TFT type or equivalent and is positioned in such a way as to optimize the access costs to the data.

7. The complex multifunctional apparatus according to claim 1, wherein said keyboard is comprised of keys, wherein at least one key is an ON key on one part and an OFF on another placed astride of the frame, with a roughened surface;
wherein at least one key is a rounded activation key of the “hands-free” function under the ON key on one side, and a second rounded key in relief positioned below the OFF key on the other side with the intended functions;
wherein at least one key is an index function keys positioned closer to the driver and more accessible even without looking;
wherein at least one key is a scroll-up function key;
wherein at least one key is a scroll down function key;
wherein at least one key is a messages function key; and
wherein at least one key is an alphanumeric keys sequence with double function and two conventional asterisk and delete keys or with touch screen technology.

8. The complex multifunctional apparatus according to claim 1, wherein the rear-view mirror provides an orientable camera along an upper edge thereof.

9. The complex multifunctional apparatus according to claim 2, further comprising a third section connected to the first and second section, said third section comprising:
a logic control device which manages a video-conference system connected to the LCD-TFT driver of the second section, a display being connected to the logic control and management device of the audio system of the first section; and
a video section, by the logic control device, being connected to the camera and integrates the UMTS function with the related antenna or wireless type connection WiFi.

10. The complex multifunctional apparatus according to claim 9, wherein the video section comprises a GPS/GSM system with the optional possibility of having the UMTS system, with related antennae controlled by the logic control device that communicates with the LCD-TFT driver and in which a device to establish the degree of attentiveness of the driver is present.

11. The complex multifunctional apparatus according to claim 1, wherein said camera provided in the video section is interfaced both with the GPS/GSM system with the optional possibility of having the UMTS system as well as with the device to establish the degree of attentiveness of the driver and in that both functions are controlled by the logic control device which, in this case, is equipped with an audible warning device to signal the attention of driver, with at least one possible alarm device to a call reception centre and with a conference video system.

12. The complex multifunctional apparatus according to claim 1, wherein the monitor is separated from the reflective surface.

13. The complex multifunctional apparatus, according to claim 1, wherein the monitor is housed in a pivoted appendix, in an orientable way, along the lower side of the container.

14. The complex multifunctional apparatus according to claim 1, wherein the monitor is placed, with respect to the reflective surface, at the side of the user driver.
